(19) United States
(12) Patent Application Publication
(10) Pub. No.: US 2019/0016035 A1
(43) Pub. Date: Jan. 17, 2019

(54) DEVICE AND METHOD FOR COOLING FOIL MATERIAL

(71) Applicant: GloBra GmbH, Salzburg (AT)

(72) Inventor: Wolfgang PINEGGER, Schladming-Rohrmoos (AT)

(21) Appl. No.: 16/027,746

(22) Filed: Jul. 5, 2018

Related U.S. Application Data
(63) Continuation of application No. PCT/EP2016/050033, filed on Jan. 4, 2016.

(51) Int. Cl. B29C 47/88; B29C 47/00; B29C 47/08; B29C 47/92

(52) U.S. Cl. CPC B29C 47/885; B29C 47/0021; B29C 47/0877; B29C 47/887; B29C 47/8875; B29L 2007/008; B29C 47/92; B29C 2947/92209; B29C 2947/92704; B29C 2947/92438; B29C 47/8895

(57) ABSTRACT

A device and method for cooling foil material are provided, comprising: a movable belt, wherein the belt is intended for receiving the foil material at a first predetermined position of the device, for transporting the foil material received, and for discharging the foil material at a second predetermined position, wherein the device is adapted to cool the foil material received and/or the belt.

### CROSS REFERENCE TO RELATED APPLICATION

The present application is a continuation of International Application No. PCT/EP2016/050033, filed Jan. 4, 2016, the contents of which are incorporated herein by reference.

The present invention relates to a device and a method for cooling foil material. Such devices and methods are used for the production of foil material, in particular, and endless foils made from plastic.

The production of such endless foils is carried out by applying molten plastic granulate (the so-called melt) onto a rotating cooling roll (“chill roll”, CR), where it forms a foil film, and is picked up by the rotating chill roll while being cooled, and then is separated from the chill roll, and is transported further. With respect to the thermal, mechanical, optical impermeability and other properties of the foil, also with respect to its further processing, a rapid and controlled cooling and the control and impact on the crystallization process connected therewith are particularly important. Within the process of further processing, subsequent phases may be re-heating and stretching of the foil film in the transport direction of the foil (Machine Direction Oriented, MDO), transverse with respect to the transport direction (Transverse Direction Oriented, TDO), or sequentially or simultaneously in both directions (Biaxially Oriented, BO), respectively, under heat influence, and eventually, cooling, edge cutting, and winding up on a roll.

In the following, the foil is referred to by the generic term “foil material” in all process phases or production states, irrespective of the more or less viscous starting material of the foils, namely, the melt, being concerned, the foil film being generated on the surface of the cooling body, or the film web, without, prior to or after being stretched. From the context, and in particular, from the description of the respective process step, it can be derived unambiguously, which specific state of the foil is referred to respectively.

With respect to the foils, all types may be concerned, which can be produced by application of a material from a melt by means of extrusion, e.g., by means of a flat nozzle, in one or more layers onto the surface of a rotating chill roll, and the subsequent cooling down resulting therefrom. This also concerns foils, which at the same time can be cooled on the side facing away from the roll by means of air, water, or by means of further rolls, or in other ways. However, this does not exclusively concern all polyolefin raw materials, as polypropylene (PP) and polyethylene (PE), polyester (e.g., PET), polyamide, polyactide (PLA), polystyrene, polycarbonate, and all those falling under the definition mentioned above.

In contrast to foils made from other polymers, for the foils made from thermoplastic semi-crystalline polymers, as for example, polypropylene, polyethylene, and polyester, it is decisive to cool the melt as fast as possible and preferably as strong as possible down to a predetermined temperature range in order to thereby influence the crystallization.

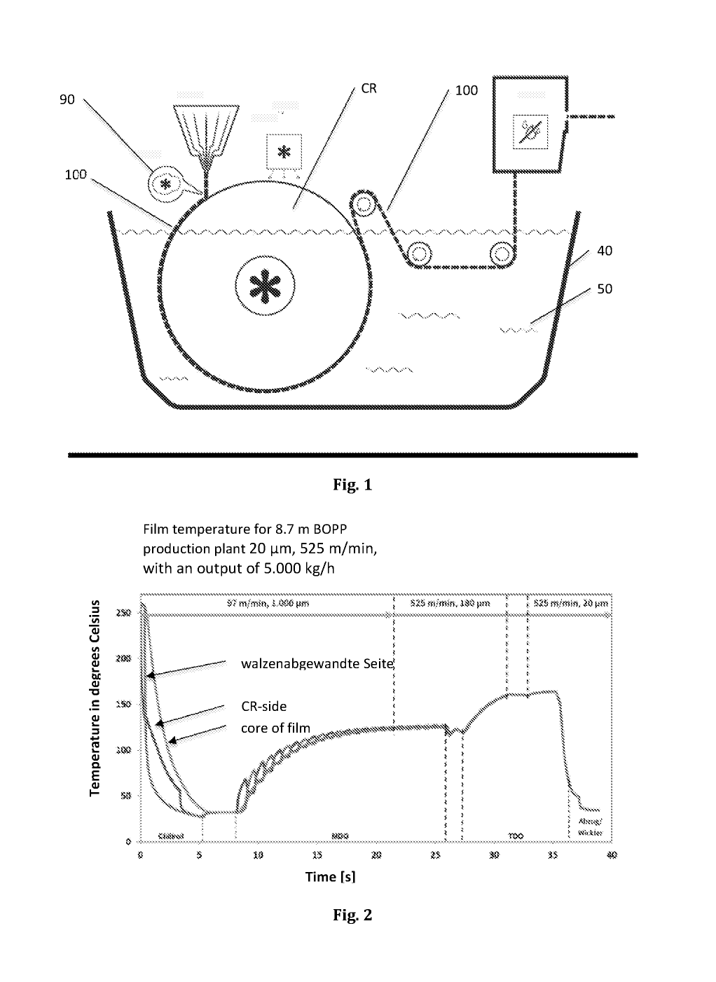

With respect to a known production method, the melt (about 260 degrees for the foil material PP) is discharged from a flat nozzle, and is applied and put onto the chill roll for rapid cooling. FIG. 1 shows a cooling device being used for this according to prior art. The cooling device comprises a chill roll CR, which is implemented in a water bath 40, 50. The foil material applied is cooled on its side facing the roll by means of the chill roll, which in turn is cooled by means of water, which flows through inner cooling channels, or which is cooled from the inside by means of spraying water.

With respect to PP, for which an air knife 90 is used for application, the cooling of the side of the foil material facing away from the roll initially results from the air flow of the air knife and then from the water bath, into which the chill roll is immersed together with the foil material. Other foil materials, as e.g., polyester, are applied by means of electro-static pinning methods to the chill roll, and have to be cooled by the chill roll, namely, from the CR side exclusively.

FIG. 2 shows temperature paths during the production of sequentially biaxially stretched PP foil at a nominal production capacity of the plant of 5,000 kg/h and a foil thickness of 20 μm during the cooling process of the foil material by means of the cooling device described above. Here, the marked lines show the temperature profile of the side of the foil material facing away from the roll and the side facing the roll, as well as the temperature profile in the foil core, respectively over time.

In this example, the cooling of the foil material, at first, takes place very fast on the (CR-) side facing the roll by the cool surface of the CR, on the side (external side) facing away from the roll also fast, but slower due to the cooling effect of the air knife. After immersion into the water bath, the side facing away from the roll is cooled stronger, also upon deflection onto eventual further chill rolls. The cooling of the film core only takes places via the surfaces of the film, and accordingly occurs with a delay. In this example, a homogeneous temperature profile through the cross-section is created only shortly after the film leaves the CR surface. In detail, these phases take place as follows:

The cooling process (“casting”) takes place at the beginning, and namely, with a melt of 260 degrees. In this example, the cooling is effected by means of a chill roll being cooled via cooling channels provided in the roll shell, and a water bath after exiting the nozzle (space for air knifes).

The first very rapid cooling effect is obtained on the film side facing the roll due to the cold CR, and on the side facing away from the roll by the air knife. After being introduced into the water bath, the cooling of the foil material on the lower side (here, still the external side) is effected by the water. The first very rapid cooling from 260 degrees takes place slightly faster on the CR side, however, both external sides are cooled down uniformly to about 130 degrees relatively fast.

Thereby, this cooling effect to about 130 degrees is already achieved shortly after entering the water bath. From this moment on, the CR side of the foil material distinctively drops in the cooling efficiency, because the CR has heated up too much, now the water bath side of the foil material cools faster. The temperature curve of the CR side only improves again as the film leaves the CR, and in this example, is immersed into the water bath for a further time and the water reaches both sides.

Thereby, the film has been within the water bath during half a loop of the CR. The CR side of the film material catches up immediately in the water bath, and these two temperature curves then, after a short time, meet each other with respect to the core temperature, which always “lags behind”, because the foil is immersed into the water bath again after being deflected from the CR. Thus, the cooling effect respectively required is obtained relatively fast in the case of cooling by means of the water bath at the external sides of the film material. The cooling effect in the film core, however, lags behind accordingly.

In this example, the further cooling process down to 30 degrees only takes place, because the system proceeds and the homogeneous target temperature down to the core of the foil is only obtained by the cooling of the foil material separated from the CR in the water bath.

As can be seen in FIG. 2, in the region from second 9 to 26 and 27 to 31, the foil material is heated up again subsequently, in this example up to about 130 degrees or 150 degrees, in order to be MDO or TDO stretched.

Every cooling down exceeding the necessary degree uses, in case of further necessary heating processes, e.g., in connection with stretching, unnecessary energy.

Ultimately, the film is also cooled more often and longer in order to achieve a very fast and homogeneous cooling of the film than this would have to be necessary for achieving the required properties and quality features.

On the other hand, the cooling efficiency, however, defines the common output tables. FIG. 5, table a), shows the throughput in kilograms per hour and tons per year for foils of different thicknesses and plant speeds for the example of a BOPP foil using a chill roll for cooling of the extruded foil material. The 5,000 kg/h (37,500 tons/year) are to be achieved at maximum cooling efficiency of the CR plant; with respect to thicker foils, the rate has to be reduced, because the CR plant can no longer accomplishes the required cooling efficiency. For thinner foils, the plant speed (here, 525 m/min) is the delimiting factor for the output in kg. This means, the mechanical layout of the plant has to correspond to all desired thickness ranges, and thereby, has limited flexibility with respect to the individual foil thicknesses and their requirements to the desired properties.

The cooling rolls, however, seem to have reached the end of mechanical possibilities. The surface of the cooling roll and the time, in which the foil material is transported on the cooling roll, as well as the time, in which the cooling roll has to be cooled down again after separating the foil material defines the cooling efficiency of the chill roll, and thereby the throughput of the plant.

This is, amongst others, because the time, in which the CR is able to cool down again, becomes progressively smaller for the new melt with the higher velocities, and the surface is no longer cold at maximum. Moreover, here, the water also still has to be removed from the surface of the CR, for cleaning there neither is space nor time.

For a CR diameter of about 3 m, the necessary fine surface, and the required rotation accuracy, further problems arise from the clearance of the axis, the large radius and the surface. Accordingly, large chill rolls having a smooth surface and high requirements to the rotation accuracy are complex with respect to production. The same applies for the logistics of such rolls. The requirements with respect to stability of the rolls, which increase with the circumference requires mechanical concepts and materials or material thicknesses, which tend to affect the required temperature exchange negatively. Therefore, it is increasingly difficult to maintain the rotation accuracy optimally with respect to a distance between nozzle lip and CR surface always being equal. Also, the CR with its surface is a very critical replacement part, every damage leads to a very difficult complete replacement and possibly to a very long downtime of the plant.

Therefore, it is an object to provide a cooling device and an improved cooling method for foil material, by means of which the disadvantages described above can be remedied at least partially.

This object is solved by the devices and method according to the claims.

Accordingly, a device for cooling foil material is provided, comprising: a movable belt, the belt being intended for receiving the foil material at a first predetermined position of the device, for transporting the foil material received, and for discharging the foil material at a second predetermined position, wherein the device is adapted to cool the foil material received and/or the belt.

The invention also involves a method for cooling foil material, wherein the foil material is received by a movable belt at a first predetermined position, is transported, and is discharged from the belt at a second predetermined position, and wherein the received foil material and/or the belt is/are cooled.

The invention has several advantages.

The disadvantages and problems involved with the rotation accuracy of large rolls are avoided, because the belt system implements substantially smaller radii of the deflection rolls.

The easier replaceability of the belt compared to large chill rolls also is a substantial advantage. Namely, large rolls are critical, and they only can be replaced with great effort and production losses.

The foil material provided on the belt is cooled down faster, because the belt itself can be cooled better than a chill roll. Namely, the belt basically can be cooled over an arbitrary length by the water bath and/or other cooling means. The cooler surface of the steel belt also allows for a higher haul-off speed, thereby, higher plant speed and higher output of the plant.

The required very fast cooling of the foil material takes place from the side facing the belt through the foil core outwards (namely, towards the side facing away from the belt) and leads to a homogeneous cooling also of the foil core faster such that the foil material does not have to be cooled down as far as compared to using a CR.

Preferred embodiments of the invention comprise the following features.

The belt may be an endless belt, in particular, a belt made from steel, preferably, a chromium-plated or otherwise plated belt.

The belt, of course, is a planar belt, on the surface of which the foil is received in its entire width, also by means of surface contact.

The use of a thin steel belt and corresponding rolls having a smaller diameter allows for a design and construction of these chill rolls optimized for the temperature exchange, and the use of correspondingly better and thinner materials. Steel belts have very small thickness clearances, being beneficial for the rotation accuracy with respect to the gap between belt and nozzle lip and the quality features related thereto.

Further, the device may comprise: a first roll and a second roll, wherein the belt is led over the first roll and over the second roll.

Further, the device may comprise: a cooling means, in particular, a cooling liquid bath, wherein the belt and the foil material are movable through the cooling means, in particular, through the cooling liquid bath.

The first predetermined position may be located within an area, in which the belt rests on the first roll, and the roll is immersed in rotation direction together with the belt into the cooling liquid bath.

Thereby, it is ensured that the foil material is immersed into the cooling liquid bath and is cooled as fast as possible.

The first predetermined position may be located above the liquid level of the cooling liquid bath.

The cooling means, in particular, the cooling liquid bath may comprise a container and a cooling liquid. The cooling liquid may comprise water.

The first roll located at the nozzle may be configured as a chill roll, which may be closed and cooled by channels within the roll shell, or by spraying from the inside.

It may, however, be open laterally, like a water wheel, rotate in the water bath and cold water is supplied internally and sprayed thereon. The second roll may be configured equally, namely, may cool again, or may only deflect.

The cooling of the side (external side) facing away from the belt by means of the water bath and so on, thereby, is supported from the side (internal side) facing the belt.

A “lagging behind” of the cooling at the internal side when using a water bath can be prevented or reduced, because the belt may be cooler and the foil may be released from the belt faster due to the smaller radius of the nozzle-sided belt deflection or a further adjustable deflection roll, and e.g., the water bath is able to have an effect on both sides as well as for further cooling the belt.

The foil material may, if necessary, remain at the belt, also at the second roll or further rolls over which the belt passes, and thus may be cooled further.

Thus, the cooling can be monitored and controlled substantially better.

Thereby, an improved cooling efficiency and a flexible plant adjustable to the respectively required properties, quality parameters, and foil thicknesses with respect to the cooling behavior, with corresponding advantages concerning consumption of cooling energy, stretch films are obtained.

The surface of the belt is kept warm by the hot foil, only as long as it is absolutely necessary, thereafter, the foil obtains the corresponding cooling energy alone.

The belt runs on its internal side (also the side of the belt resting on the rolls) in the cold water bath freely, and thereby is cooled. As soon as the foil is led away from the belt, the belt is also cooled by the water on its external side. Thereafter, the belt passes over a further chill-/deflection roll optionally with or without foil, and thereby is cooled further. Then, the belt has a longer distance at which it, if necessary in any arbitrary manner, possibly by means of cold air, may be cleared from water and also be cleaned, is further cooled, and the temperature may be measured prior to new melt being supplied. This measurement allows for an optimal adjustment of the respective cooling situation and the water temperature to a corresponding production situation.

The device may further comprise: a tension device for the belt.

The device may further comprise: means for separating the foil material from the belt at the second predetermined position.

The device may further comprise: an air or other cooling means for cooling the belt in a region between the second predetermined position and the first predetermined position.

The device may further comprise: a lay-on system for the melt, in particular, an air knife or an electro-static pinning system.

The device may further comprise: at least one third roll, wherein the at least one third roll may be arranged so as to guide the foil material and/or the belt.

The at least one third roll may be arranged so as to release the foil material from the belt.

The tension means may comprise the second roll and/or the third roll. The second roll and/or the third roll may have a smaller diameter than the first roll.

The second roll or further deflection rolls is/are adjustable in its/their position/-s arbitrarily, i.e., it is possible to arrange them respectively within the liquid bath or outside of it.

E.g., at least one possibly further roll, in this example located within the water bath, which is adjustable horizontally and vertically, allows for a targeted deflection of the foil from the belt; further deflection rolls for the foil, which also are adjustable horizontally and vertically, allow for a shorter or longer stay of the foil in the water bath.

The water bath, which in contrast to a plant implementing a large chill roll, does not have to be high or deep but rather long and flat, may be operated substantially easier.

On its path back to the nozzle, the belt then may be cleared from water and from other contaminations from the foil or from the water bath easily.

As a consequence, the belt may be cooled further by means of any technically possible cooling means, and this cooling may be measured and controlled accordingly.

The device may further comprise: means for measuring temperatures of the belt at predetermined positions and/or at at least one of the rolls and/or the cooling means, and for influencing the cooling efficiency of the cooling means depending on the temperatures measured.

The device may further comprise: a monitoring means for monitoring at least one of drying, contamination, temperature of the foil material.

The device may further comprise: a cleaning means for removing adhesions from the belt.

Further, the return path of the belt allows for arranging further means for cleaning, drying, cooling, measuring the temperature, as well as optical or other monitoring means, respectively with respect to the belt.

The foil material may be one of polyolefine raw materials, polyester, polyamide, PLA, polystyrene, polycarbonate.

The foil material may generally be a semi-crystalline thermoplastic material.

For foils, which are not cooled by means of a water bath, as e.g., polyester foils (PET), the cooling results exclusively via the belt, which itself is cooled via the deflection rolls configured as chill rolls and/or other possible cooling means on the return path of the belt. Here too, the selection of the length of the belt achieves an improved cooling efficiency or the cooling efficiency being better adjustable. This improved cooling efficiency and the temperature control, here, is even more important, because e.g., the polyester foil material for foils for which the water bath is omitted, as for example PET foils, is supplied to the belt substantially hotter and more liquid, e.g., as PP melt. Here, the entire cooling results from the inside through the core to the outside; the exact control and a very cold belt are of great importance.

The device may further comprise: an extrusion device for melting and application of the foil material onto the belt, in particular, by means of a flat nozzle. The foil material may be applied to the belt by means of an extrusion device, in particular, by means of a flat nozzle.

Also, the invention comprises a method for producing foil material, wherein the method according to the invention described above is employed.

The invention also comprises a foil, in particular, an endless foil, which is produced or which can be produced using the method according to the invention.

The invention and embodiments thereof are described by means of the drawing in further detail, in which

FIG. 1 shows a conventional cooling device by means of a cooling roll (chill roll) and water bath;

FIG. 2 shows temperature paths over time for a known cooling device for a foil production plant 20 μm, 525 m/min, a total stretching ratio 50 with an output at the winder of 5.000 kg/h;

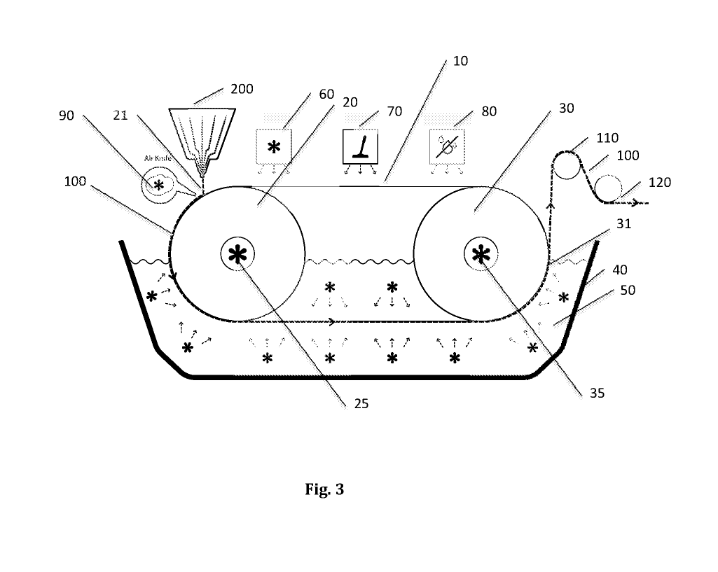

FIG. 3 a first embodiment of the invention;

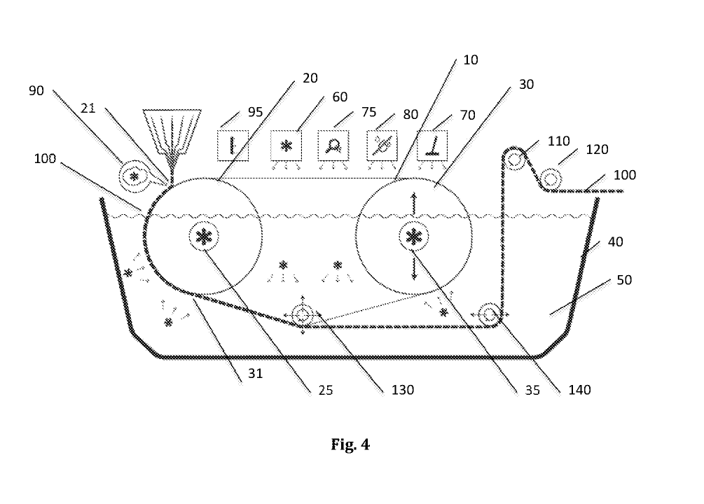

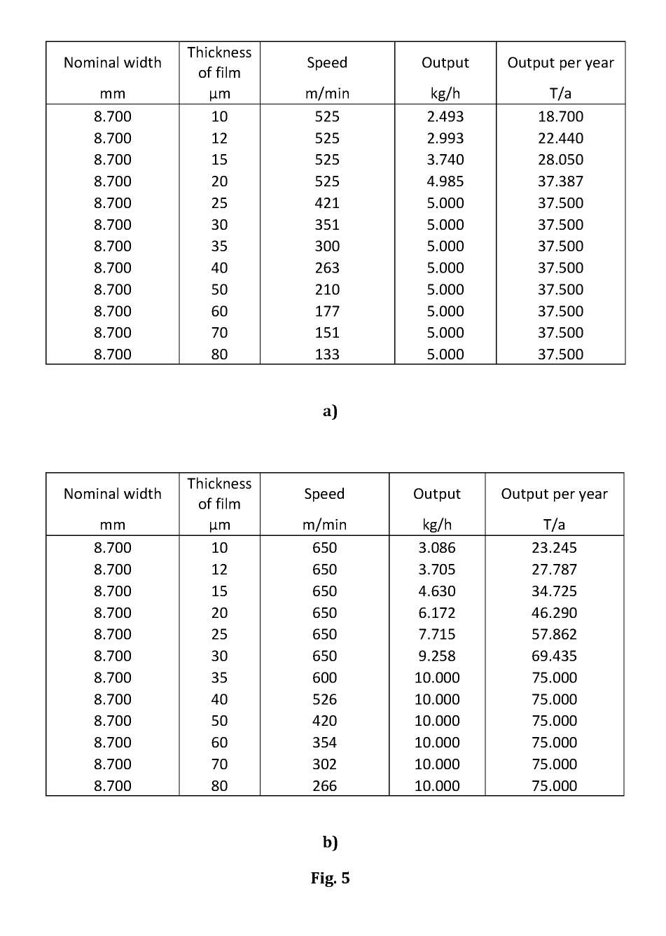

FIG. 4 a second embodiment of the invention;

FIG. 5 output tables for a conventional cooling plant (table a)) and possible output tables for a cooling device according to the invention (table b)); and

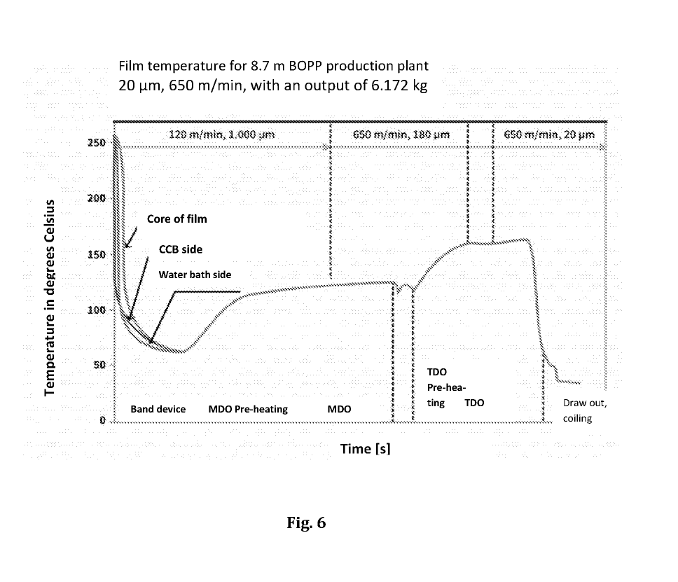

FIG. 6 an exemplary temperature curve for a cooling device according to the invention for a foil production plant 20 μm, 650 m/min, a total stretching ratio 50 with an output at the winder of 10.000 kg/h.

With respect to the first embodiment of the invention according to FIG. 3, the device for cooling foil material 100 comprises a movable belt 10, wherein the belt is intended for receiving foil material 100 at a first predetermined position 21 of the device, for transport of the received foil material 100, and for discharging the foil material 100 at a second predetermined position 31, and a cooling means 40, 50, which is intended for cooling the belt 10 and/or the received foil material 100. The belt 10 is an endless belt made from steel and preferably, is chromium-plated. The belt is directed over a first roll 20 and a second control 30. The rolls 20, 30 serve for deflection and driving of the belt 10.

The first predetermined position 21 in the direction of movement of the belt is located in front of the entrance of the belt 10 into the cooling means 40, 50, and is located in an area, in which the belt 10 rests on the first roll 20.

The cooling means, here, comprises a cooling liquid bath 40, 50. The cooling liquid bath comprises a container 40 with a cooling medium 50, here, water. At least one of the rolls 20, 30, in this embodiment both rolls 20, 30, are arranged at least partially within the cooling liquid bath 40, 50.

The first predetermined position 21, namely, that position at which the foil material 100 is applied onto the belt 10, is located in the area of the first roll 20 above the water level of the cooling liquid bath 40, 50. The first roll 20 is that one of the two rolls 20, 30, which in the direction of movement of the belt is closer to the position at which the belt is immersed into the cooling liquid bath 40, 50. Thereby, it is ensured that the foil material is immersed into the water bath immediately after it has been applied, and thereby, is cooled uniformly and homogeneously from both sides.

For the application of the foil material 100 out of the melt, e.g., an extrusion device 200 is provided. The molten granulate arrives, via melt lines, at a flat nozzle, through which the melt then is applied through the nozzle slot onto the belt 10.

An air knife 90 serves for the foil material 100, as soon as it hits the belt 10, being cooled there fast and is applied uniformly over the width of the belt 10 at the surface of the belt. If the application of the foil material 100 is achieved by means of air knives, then this entails a cooling effect for the foil material 100 on the side facing away from the belt.

The belt 10 with the foil material 100 applied thereon is passed through the cooling liquid bath 40, 50. Thereby, the foil material 100 is cooled further.

The foil material 100 is separated from the belt 10 at the second predetermined position 31. The second predetermined position 31—of course—in the direction of movement of the belt is located downstream of the first predetermined position 21. The second predetermined position 31, in this embodiment, is located in an area, where the belt 10 rests on the second roll 30.

After separation, the foil material 100 is guided via further rolls 110, 120 and is passed over to a subsequent means for renewed heating and stretching, cutting, and/or for winding.

Further, a means may be provided, which keeps the belt 10 under tension. This means may be integrated into either one of the rolls 20, 30. The tension means is advantageous, if the distance of the two rolls 20, 30 is modifiable and it has to be ensured that the belt, at constant belt length, nevertheless is stretched for every distance set and does not slip.

Slipping of the belt may be prevented by the configuration of the surface of the rolls and the side of the belt facing the rolls.

According to a modification of the first embodiment, the diameter of the second roll 30 may be smaller than the diameter of the first roll 20. Then, the foil material 100 may be released from the belt 10 and already at a very early stage and thus, after a very short distance in the water bath, and may be guided outside of the water bath 40, 50. The second roll 30, here, preferably is arranged completely outside of the cooling liquid bath 40, 50.

FIG. 4 shows a second embodiment of the invention. According to this embodiment, the belt is still led over a third roll 130, which is arranged in the water bath 40, 50 between the two rolls 20, 30. At this roll 130, the foil material 100 is detached from the belt 10, and is then guided over a fourth roll 140, which also is located within the water bath, out of the water bath to the rolls 110 and 120.

The rolls 130, 140 may be displaceable vertically and horizontally such that the length, over which the foil material is led within the water bath and thereby, the cooling efficiency, may be varied individually according to the requirements. The rolls 130, 140 may have a smaller diameter than at least the first roll 20.

The third roll 130 (possibly together with further rolls 140) thus enables a detachment of the foil material from the belt at an arbitrary position and a flexible adjustment of the distance over a further deflection roll, by means of which the foil material remains in the water bath.

Also here, a means may be provided, which keeps the belt 10 under tension. For this, the third roll 130 may be configured as tension mechanism for the belt 10.

The tension device also is advantageous for releasing the belt 10 when being replaced. The roll 20 is to be kept stable and fixed during ongoing operation, it may only be driven into a controlled replacement position during a replacement of the belt. The roll 30 and the third roll 130, moreover, ensure the tension equalization of the system during the ongoing operation, e.g., during changes of foil thicknesses. Otherwise, all embodiments of the device, which are described above with reference to the first embodiment or with respect to the modified first embodiment, may be transferred individually or in combination to this second embodiment.

Also applicable for all embodiments:

Preferably, the foil material 100 (the melt) hits the belt 10 at a particularly stable position of the belt 10, namely, at a location, where the band 10 rests on the first roll 20.

The length of the cooling liquid bath 40, 50 may be configured differently according to the cooling requirements. The cooling requirements depend, amongst others, on the desired throughput of the plant and the requirements to the properties and quality criteria determined by the cooling efficiency. Because the belt, for example, with foil material or without foreign material is passed between the rolls 20, 30 freely within the water bath 40, 50, basically, “cooling paths” of any arbitrary length may be realized. Thereby, also a belt with foil material running very fast still may be cooled sufficiently. Otherwise, the belt may be cleared again on the “return path” (without foil material) from water, and may also be cooled as well as monitored, and the temperature may be measured. For this, the belt may be directed, if needed, over further rolls at corresponding means.

The water bath may also be much longer, respectively according to the design of the plant, compared to the belt plant only. Thus, for example, thicker foils may be guided through the water bath longer than thinner foils. By the water circuit and the controlled supply of the cold water, the cooling of the foil and the belt may be further optimized and controlled.

Because the belt 10 and the foil material 100 move through the water bath, the belt and the foil material can be cooled from both sides, ensuring a more uniform cooling of the foil material in cross-section, but also enabling a faster cooling of the foil material.

In contrast to a CR, the circumference of the rolls 20, 30, here, is not decisive for the cooling efficiency of the plant. The path, on which the foil material is cooled, primarily is not determined by the circumference of the roll, but rather, amongst others, by the length of the area, in which the belt runs within the water, or is cooled by other cooling means.

In all embodiments, one or more of the following functional groups may be present:

Means 70 for cleaning the belt from dirt. The cleaning may be carried out, e.g., by means of (cooling-)water, brushes, (cold) air, or a combination thereof.

Means 80 for the removal of water (by means of blowing) from the belt. The blowing off of water from the belt is the first means (in the direction of movement of the belt) at or behind the roll 30. The blowing off of water preferably results by means of cold air. The ambient temperature, here, is relatively high, due to the extruder, the melt lines, and the nozzle.

Means 60 for additional cooling of the belt; if necessary, the belt return path (namely, the area between the second predetermined position 31 and the first predetermined position 21 in the direction of movement of the belt) may also be used in order to cool the belt additionally. Thereby, all cooling methods being technically possible may be employed.

Means 75 for monitoring the belt with respect to damages and/or residues. These means are located in the area of the belt between the second predetermined position 31 and the first predetermined position 21, and operate on the belt or monitor the belt outside of the water bath, virtually “on the return path” to that position, where the foil material 100 is applied.

Means 95 for measuring the temperature of the belt, the foil material, and the water bath may also be present. Measuring means may be provided, which measure the exact temperature of the belt immediately before the new melt is supplied, and thereby allow for an accurate control of the entire cooling process, starting from the roll temperature up to the water temperature and all cooling means.

Subsequently, an optical automatic cleaning control may take place, which interacts with the cleaning intensity.

Preferably, the space being respectively necessary may be provided by the corresponding length of the belt.

Referring to the drive of the belt 10, this may be carried out uniformly and correspondingly controllably with the optimal belt velocity respectively. For the present invention, the drive, because two rolls 20, 30 are available for this, may result from both by means of electronically controlled direct drives, or via either one of the two rolls.

As long as it is ensured that the belt runs absolutely uniform, it is advantageous to only drive one of the rolls 20, 30, in particular, the second roll 30, which may also be of a smaller dimension, as described above, than the first roll 20, and the axis of which or also the entire roll may also be located outside of the water.

Concerning the design of the rolls 20, 30, one or both may be closed laterally, and may be cooled internally. For this, one or both rolls 20, 30 may respectively comprise a cooling means 25, 35 provided in the interior of the roll, for cooling the belt.

Alternatively, one or both rolls 20, 30 may be open completely or partially such that they operate like an open water wheel in the water bath. The supply of cold water may be controlled correspondingly.

The first roll 20 may have its axis located within the water bath and may, as long as it is not operated as an open water wheel, be supplied with a cooling medium for cooling from the inside. By distributing the functions described above on both rolls 20, 30, namely, cooling by the first roll 20, drive by the second roll 30, the complexity of the individual rolls is reduced.

Summarizing the above, a particular advantage is that a long and flat cooling liquid bath is enabled, which is realized by the small roll diameter during use of the belt. Thereby, compared to a high and short water bath of a conventional CR, there are better possibilities to control the water amount and temperature, and also a larger amount and surface, which can be cleaned more easily. Also, the foil material may be cleaned more easily from dirt, which it picks up from the water bath. The water may be controlled better with respect to its temperature by targeted supply of cooling liquid to the locations, where it actually is needed. The long water bath is easily accessible (e.g., for the threading of the foil), and it has a larger water surface, where contaminations may flow in and then may be skimmed off such that they cannot reach the belt or the foil again. This is a substantial problem with respect to the CR, it practically picks up all contaminations. Also for this reason, the foil remains on the CR as long as possible, namely, the contaminations remain on the foil, and do not reach the CR. Nevertheless, at the edges, however, they do accumulate.

Moreover, higher foil output efficiency may be achieved by the cooling device according to the invention. At first, FIG. 5 shows table a) for a known plant with cooling by means of a chill roll. Here, with the fastest machine 525 m/min for BOPP at maximum cooling efficiency referred to foil at the winder (after edge cutting) of 5,000 kg/h is achieved. Table b) of FIG. 5 is applicable for a plant with belt cooling according to the invention, designed for a maximum cooling efficiency of 10,000 kg/h and a rate of 650 m/min with otherwise equal conditions. Thus, a higher foil output can be achieved by the cooling device according to the invention, as far as plant components which are placed upstream and downstream allow this.

FIG. 6 shows a temperature curve of the cooling device according to the invention for a foil production plant 20 μm, 650 m/min, a total stretching ratio 50 with an output at the winder of 10000 kg/h. As can be seen, the temperature curves decrease for the film core (the film interior), the side facing away from the belt, as well as the side facing the belt virtually equally steep, and already meet each other at a higher temperature, here in the example, at about 60 degrees. With respect to the known CR plant (FIG. 2), the three temperature curves run substantially differently, and meet each other only with a far stronger cooling down to about 30 degrees.

With respect to a further embodiment of the invention, the cooling liquid bath is omitted. Here, the foil material is cooled by the belt 10. For this, the belt 10 itself may be cooled at least by one of the rolls 20, 30. The roll 20 and/or the roll 30 may then be cooled from the roll interior side, namely, may comprise an internal cooling means 25, 35. This embodiment is particularly suitable for foil material made from polyester (e.g., PET) and all foil materials, for which the use of a water bath for cooling is not possible, which are brought from a hot melt onto the belt. Here, the cooling of the foil material 100 results from the belt 10, i.e., from the side of the foil material 100 facing the belt. The cooling efficiency of the belt 10, here, in particular, is determined by the temperature of the belt 10 during supply of the melt, the cooling of the belt by the cooled deflection roll(s), and the length of the area, in which the foil material 100 rests on the belt 10 and is transported by the belt 10. The advantages from the length of the belt, its easier cooling, cleaning, monitoring and measuring are applicable correspondingly.

A third roll 130 or further rolls, here, are advantageous in order to improve the contact of the foil material 100 to the belt 10, and thereby, improve the cooling.

With respect to this embodiment, an electro-static pinning means for rapid and uniform supply of the foil material over the width of the belt 10 is provided.

Otherwise, the embodiments described above and the advantages (e.g., cooling, cleaning, measurement) are applicable correspondingly for this embodiment.

The device according to the invention may be divided into a “drive side” and an “operation side” for all embodiments and variants described. The drive side comprises drives, motors, lines, and the operation side can be opened for cleaning and maintenance work.

1. A device for cooling stretch foil material, comprising:
a movable belt, wherein the belt is intended for receiving the foil material at a first predetermined position of the device, for transporting the received foil material, and for discharging the foil material at a second predetermined position,
a first roll and a second roll, wherein the belt is led over the first roll and over the second roll,
wherein the device is adapted to cool the received foil material (100) and/or the belt,
a cooling liquid bath, wherein the belt and the foil material are movable through the cooling liquid bath,
wherein the first predetermined position being located in an area, where the belt rests on the first roll and the roll is immersed into the cooling liquid bath together with the belt in rotation direction,
and wherein the second predetermined position being located in an area where the belt rests on the second roll, and
means for blowing water off from the belt the means for blowing water off from the belt being the first means located in the direction of movement of the belt at or behind the second roll.

2. The device of claim 1, wherein the belt is an endless belt, in particular, a belt made from steel, preferably, chromium-plated.

3. (canceled)

4. (canceled)

5. (canceled)

6. The device of claim 1, wherein the first predetermined position is located above the liquid level of the cooling liquid bath.

7. (canceled)

8. The device of claim 1, further comprising: at least one third roll, wherein the at least one third roll is arranged so as to guide the foil material and/or the belt.

9. The device of claim 1, wherein the second roll and/or the at least one third roll are modifiable with respect to their respective position.

10. The device of claim 1, further comprising: a tension means for the foil.

11. The device of claim 10, wherein the second roll and/or the at least one third roll has a smaller diameter than the first roll.

12. The device of claim 1, further comprising: means for separating the foil material from the belt at the second predetermined position.

13. (canceled)

14. (canceled)

15. The device of claim 1, wherein at least one of the rolls comprises a cooling means inside the roll for cooling the belt.

16. The device of claim 1, further comprising: a cooling means for cooling the belt in an area between the second predetermined position and the first predetermined position.

17. The device of claim 1, further comprising: a lay-on system for the melt, in particular, an air knife or an elect-static pinning system.

18. The device of claim 1, further comprising: a cleaning device for removing adhesions from the belt.

19. (canceled)

20. The device of claim 1, further comprising: means for measuring temperatures of the belt at predetermined positions and/or of at least one of the rolls and/or the cooling means and for influencing the cooling efficiency of the cooling means depending on the temperatures measured.

21. The device of claim 20, further comprising a monitoring means for monitoring at least one of drying, contamination, temperature, of the foil material.

22. The device of claim 1, further comprising: an extrusion device for melting the foil material and for applying the molten foil material to the belt.

23. A method for cooling stretch foil material, wherein the foil material is received by a movable belt at a first predetermined position, is transported, and is discharged from the belt at a second predetermined position, and wherein the foil material received and/or the belt is/are cooled,
wherein the belt is led over a first roll and over a second roll,
wherein the belt and the foil material are moved through a cooling liquid bath,
wherein the first predetermined position being located in an area, where the belt rests on the first roll and the roll is immersed into the cooling liquid bath together with the belt in rotation direction,
and wherein the second predetermined position being located in an area where the belt rests on the second roll, and
wherein water is blown off from the belt by a means for blowing water off, the means for blowing water off being the first means in the direction of movement of the belt at or behind the second roll.

24. The method of claim 23, wherein the belt is an endless belt, in particular, a belt made from steel, in particular, chromium-plated.

25. (canceled)

26. (canceled)

27. (canceled)

28. The method of claim 23, wherein the first predetermined position is located above the liquid level of the cooling liquid bath.

29. The method of claim 23, wherein the foil material and/or the belt is/are guided over at least one third roll.

30. The method of claim 23, wherein the foil material is separated from the belt by means of the at least one third roll and a further roll.

31. The method of claim 23, wherein the belt is kept under tension, in particular, by one of the rolls.

32. The method of claim 23, wherein the foil material is kept under tension by at the least one third roll.

33. The method of claim 32, wherein the second roll and/or the at least one third roll are modifiable with respect to their respective position.

34. The method of claim 33, wherein the second roll has a smaller diameter than the first roll.

35. The method of claim 23, wherein at least one of the rolls is cooled by a cooling means provided inside the roll, and the belt is cooled by the at least one cooled roll.

36. The method of claim 23, wherein at least the side of the foil material facing away from the belt is cooled by means of a cooling means in the area between the second predetermined position and the first predetermined position.

37. The method of claim 23, wherein the foil material is put on the belt by means of a lay-on system, in particular, by means of an air knife or an electro-static pinning system.

38. The method of claim 23, wherein the belt is cleared from adhesions by means of a cleaning means.

39. The method of claim 23, wherein the belt is dried, cleared from water, and/or cleaned in the area between the second predetermined position and the first predetermined position.

40. The method of claim 23, wherein temperatures of the belt are measured at predetermined positions and/or at least at one of the rolls and/or the cooling means, and the cooling efficiency of the cooling means is influenced depending on the temperatures measured.

41. The method of claim 23, wherein the foil material is monitored with respect to drying, contamination, temperature.

42. The method of claim 23, wherein the foil material is melted by means of an extrusion device, and is applied to the belt, in particular, by means of a flat nozzle.

43. A method for producing foil material, wherein the method of claim 23 is used.
